(19) United States
(12) Patent Application Publication
(10) Pub. No.: US 2025/0271669 A1
(43) Pub. Date: Aug. 28, 2025

(54) HEAD-UP DISPLAY

(71) Applicant: Panasonic Automotive Systems Co., Ltd., Kanagawa (JP)

(72) Inventors: Masayuki MIKI, Kanagawa (JP); Nobuhiko SASAKI, Kanagawa (JP); Daiki KAWAI, Kanagawa (JP)

(73) Assignee: Panasonic Automotive Systems Co., Ltd., Kanagawa (JP)

(21) Appl. No.: 19/050,244

(22) Filed: Feb. 11, 2025

(30) Foreign Application Priority Data
Feb. 28, 2024 (JP) 2024-028278

(51) Int. Cl. G02B 27/01; B60K 35/231

(52) U.S. Cl. CPC G02B 27/0101; B60K 35/231

(57) ABSTRACT

A head-up display includes: a second housing including a wall; and a plate-shaped cover supported by a placement surface of the housing (second housing) and covering a second opening of the housing. The wall includes: a pair of first extensions extending in the X-axis direction; a pair of second extensions extending in the Y-axis direction; and a plurality of claw parts disposed along the wall. The cover includes a plurality of first engagement portions formed corresponding to the plurality of claw parts. The plurality of claw parts include pressers protruding from the wall toward the second opening. The second housing holds the cover in a curved state by surrounding the cover with the pair of first extensions and the pair of second extensions and sandwiching the cover between the placing surface and the pressers engaged with the plurality of first engagement portions.

### CROSS REFERENCE TO RELATED APPLICATION

The present application is based on and claims priority of Japanese Patent Application No. 2024-028278 filed on Feb. 28, 2024.

### FIELD

The present disclosure relates to a head-up display.

### BACKGROUND

Patent Literature (PTL) 1 discloses a projection device provided in a vehicle and capable of projecting an image. The projection device includes a housing that includes a wall provided with an opening for allowing display light to pass toward the outside, and a plate-shaped cover that is translucent and closes the opening from the outside. The wall includes a pair of edges extending in a first direction, and a plurality of claw parts arranged in the first direction on each of the pair of edges. The cover includes a plurality of through holes arranged corresponding to the plurality of claw parts. The claw part includes a base protruding outward from the edge, and a presser protruding in the first direction from the leading end of the base. The housing holds the cover in a state where the cover is sandwiched between the edge and the pressers inserted into the through holes.

### CITATION LIST

### Patent Literature

PTL 1: Japanese Unexamined Patent Application Publication No. 2022-123194

### SUMMARY

However, the projection device according to PTL 1 can be improved upon.

Therefore, the present disclosure provides a head-up display capable of improving upon the above related art.

A head-up display according to one aspect of the present disclosure is a head-up display provided in a vehicle to project image light onto an object capable of transmitting and reflecting light, and form a virtual image on a side opposite to an observer relative to the object, the head-up display including: an image-generating device configured to project the image light onto the object; a housing that houses the image-generating device, and includes an opening and a wall disposed around the opening, the opening allowing the image light to pass to outside; and a cover that is plate-shaped, is supported by a placement surface of the housing, and covers the opening. The wall includes: a pair of first extensions facing each other across the opening and extending in a first direction; a pair of second extensions extending in a second direction different from the first direction; and a plurality of claw parts arranged along the wall. The pair of first extensions are curved toward the image-generating device. The cover includes a plurality of first engagement portions that are provided corresponding to the plurality of claw parts. Each of the plurality of claw parts includes a presser that protrudes from the wall toward the opening. The housing holds the cover in a curved state by surrounding the cover with the pair of first extensions and the pair of second extensions and sandwiching the cover between the placement surface and the presser engaged with each of the plurality of first engagement portions.

According to the head-up display of the present disclosure, it is possible to inhibit the cover from lifting while inhibiting an increase in size.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view illustrating a head-up display, provided in a vehicle, according to an embodiment.

FIG. 2 is a perspective view illustrating the head-up display according to the embodiment.

FIG. 3 is an exploded perspective view illustrating a cover and a second housing of the head-up display according to the embodiment.

FIG. 4 is a sectional view illustrating a windshield and the head-up display.

FIG. 5 is a partial plan view illustrating a part of the second housing, including a wall, a placement surface, a plurality of claw parts, protrusions, and the like.

FIG. 6 is a perspective view illustrating a first claw part and a first engagement portion.

FIG. 7 is a sectional view illustrating the first claw part and the first engagement portion along line A2-A2 in FIG. 6.

FIG. 8 is a sectional view illustrating the cover, the wall of the second housing, and the drainage structure of the second housing, along line A1-A1 in FIG. 2.

FIG. 9 is an explanatory view illustrating how the cover is attached to the second housing.

### DESCRIPTION OF EMBODIMENT

Hereinafter, an exemplary embodiment will be specifically described with reference to the drawings.

Note that the embodiment described below shows either general or specific examples. Numerical values, shapes, components, placement positions and connection forms of the components, and the like shown in the following embodiment are examples and are not intended to limit the present disclosure. Among the components in the following embodiment, components not recited in the independent claim will be described as optional components.

Each of the drawings is a schematic diagram and is not necessarily illustrated exactly. Therefore, for example, the scale and the like may not necessarily be consistent across the drawings. In the drawings, the same reference numerals are assigned to substantially the same components, and a duplicate description may be omitted or simplified.

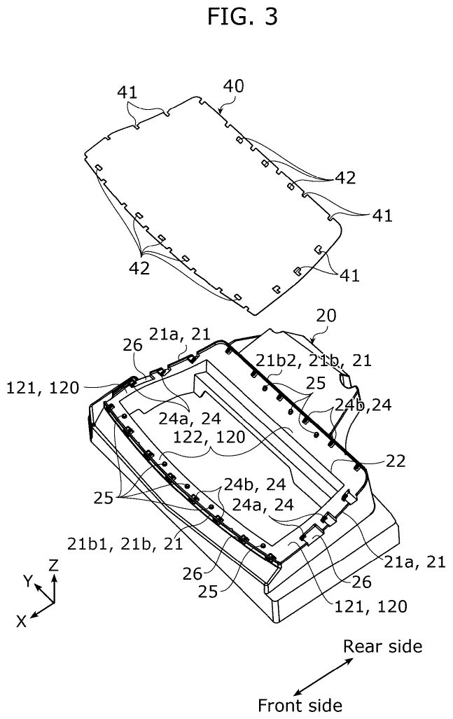

In the following embodiment, in FIG. 2, the front side of the vehicle is defined as the positive X-axis direction, and the right side, when viewed along the front of the vehicle, is defined as the positive Y-axis direction. The upper side in the vertical direction, perpendicular to the positive X-axis and the positive Y-axis directions, is defined as the positive Z-axis direction. The direction of FIG. 2 is also applied in FIG. 3 and subsequent figures.

In the following embodiment, expressions such as X-axis direction, rectangular shape, and substantially parallel are used. For example, the X-axis direction does not necessarily mean the perfect X-axis direction, the rectangular shape does not necessarily mean perfectly rectangular, and substantially parallel does not necessarily mean perfectly parallel. However, these expressions also mean substantially the X-axis direction, substantially rectangular, and substantially parallel, that is, including a margin of error, such as a few percent. In addition, the X-axis direction, rectangular shape, and substantially parallel mean the X-axis direction, rectangular shape, and substantially parallel in the range where the effects of the present disclosure can be achieved. The same applies to other expressions using “direction”, “shape”, or “substantially”.

### Embodiment

### Configuration

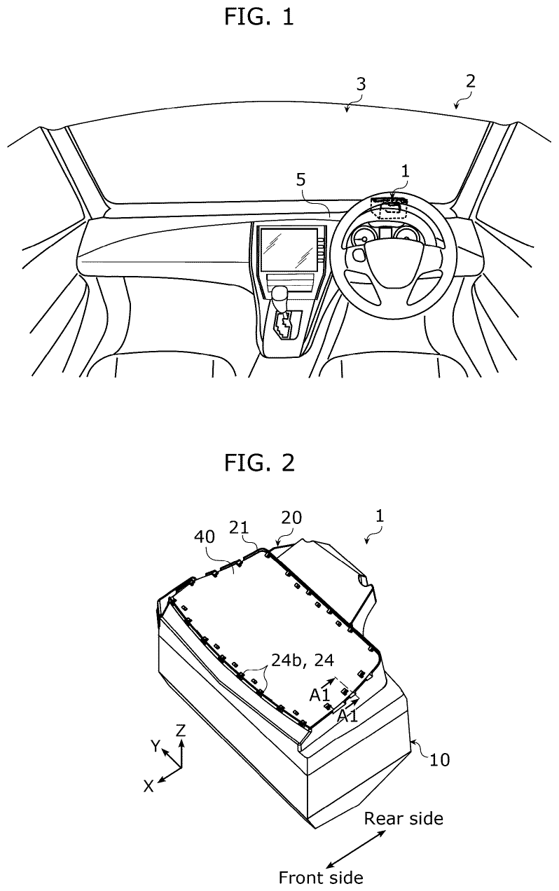

Head-up display 1 of the present disclosure will be specifically described below with reference to FIGS. 1 to 9.

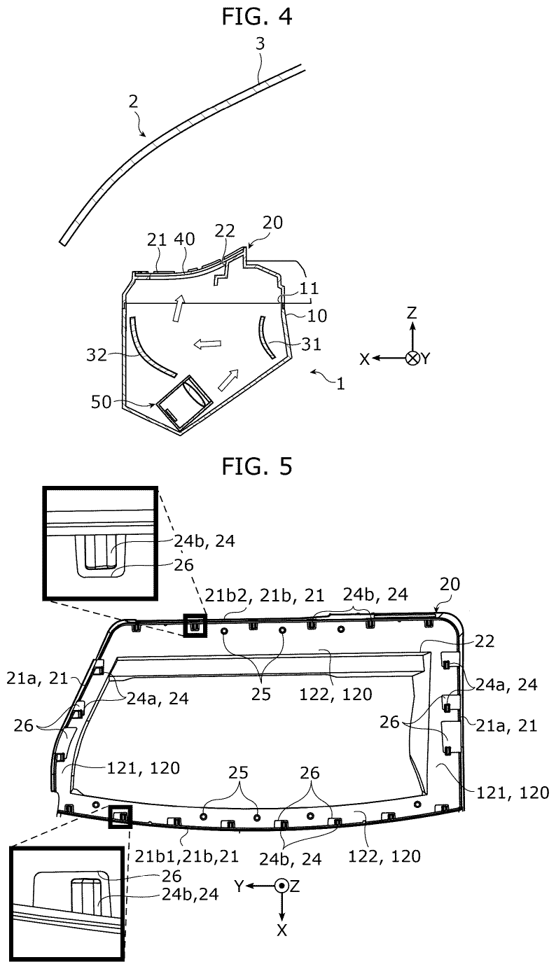

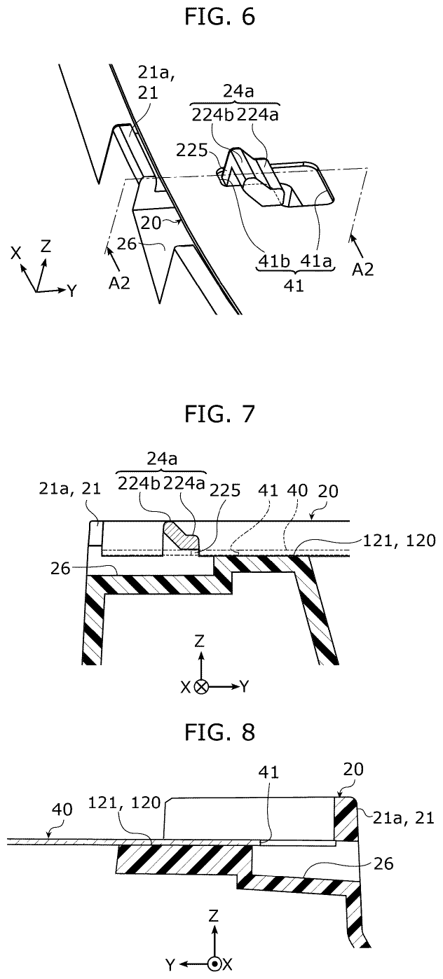

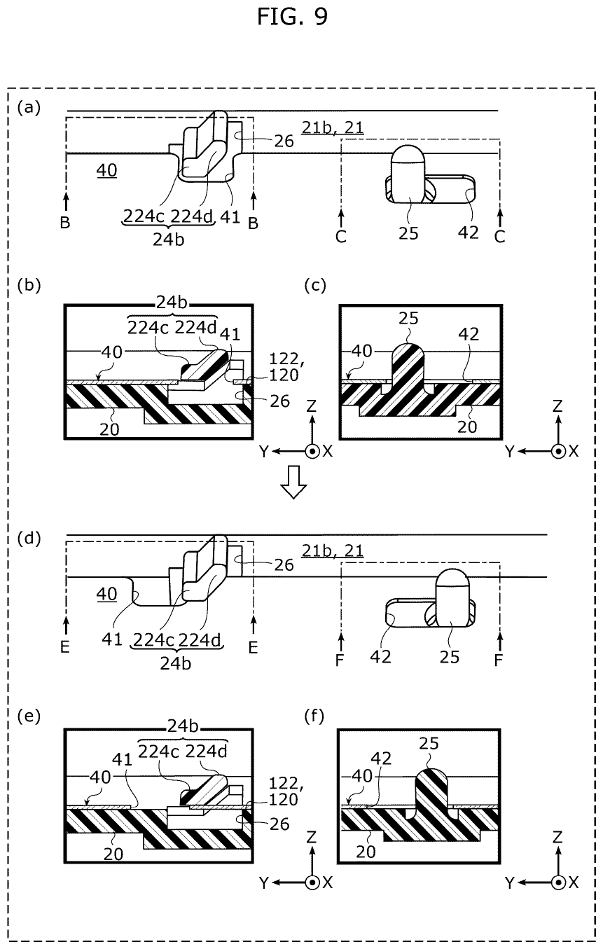

FIG. 1 is a perspective view illustrating head-up display 1, provided in vehicle 2, according to an embodiment. FIG. 2 is a perspective view illustrating head-up display 1 according to the embodiment. FIG. 3 is an exploded perspective view illustrating cover 40 and second housing 20 of head-up display 1 according to the embodiment. FIG. 4 is a sectional view illustrating windshield 3 and head-up display 1. FIG. 5 is a partial plan view illustrating a part of second housing 20, including wall 21, placement surface 120, the plurality of claw parts 24, protrusions 25, and the like. FIG. 6 is a perspective view illustrating first claw part 24a and first engagement portion 41. FIG. 7 is a sectional view illustrating first claw part 24a and first engagement portion 41 along line A2-A2 in FIG. 6. FIG. 8 is a sectional view illustrating cover 40, wall 21 of second housing 20, and drainage structure 26 of second housing 20, along line A1-A1 in FIG. 2. FIG. 9 is an explanatory view illustrating how cover 40 is attached to second housing 20. (a) of FIG. 9 illustrates a case where claw part 24 is engaged with first engagement portion 41, protrusion 25 is engaged with second engagement portion 42, and cover 40 is placed on placement surface 120 of second housing 20. (b) of FIG. 9 is a sectional view illustrated along line B-B in (a) of FIG. 9. (c) of FIG. 9 is a sectional view illustrated along line C-C in (a) of FIG. 9. (d) of FIG. 9 illustrates a state where cover 40 is slid in the positive Y-axis direction from the state in (a) of FIG. 9, and cover 40 is sandwiched between the plurality of claw parts 24 and placement surface 120 of second housing 20. (e) of FIG. 9 is a sectional view illustrated along line E-E in (d) of FIG. 9. (f) of FIG. 9 is a sectional view illustrated along line F-F in (d) of FIG. 9.

As illustrated in FIG. 1, head-up display 1 is disposed, for example, on dashboard 5 (also referred to as an instrument panel) of vehicle 2. Windshield 3 (also referred to as a front shield) is disposed above dashboard 5 of vehicle 2. Head-up display 1 is disposed in dashboard 5.

Head-up display 1 is provided in vehicle 2, projects an image onto an object capable of transmitting and reflecting light, and forms a virtual image on the side opposite to an observer relative to the object. For example, head-up display 1 can reflect image light, representing an image emitted from image-generating device 50, onto windshield 3 as an object to display a virtual image represented by the image light for a user such as a driver. That is, head-up display 1 projects the image light emitted from image-generating device 50 onto the front of windshield 3 to display an image indicated by the image light on windshield 3. The image projected onto windshield 3 of vehicle 2 is thus visible by the user.

Here, the image light is light representing information of an image including numbers, characters, figures, and the like, and is displayed as a virtual image in the front of windshield 3. The image is a still image or a moving image, and is an image of numbers, characters, figures, and the like.

As illustrated in FIGS. 2 to 4, head-up display 1 includes first housing 10, image-generating device 50, first reflective mirror 31, second reflective mirror 32, second housing 20, and cover 40.

First housing 10 is an enclosure that houses image-generating device 50, first reflective mirror 31, and second reflective mirror 32. First housing 10 constitutes the outer shell of head-up display 1. First housing 10 is fixed to vehicle 2 while attached to dashboard 5. First housing 10 is made of resin material or metal material.

First opening 11 for disposing second housing 20 is formed on the positive Z-axis direction side of first housing 10. First opening 11 is provided to correspond to the shape and position of second opening 22 formed in second housing 20.

Second housing 20 is attached to first housing 10. Specifically, an engagement portion, disposed at the terminal edge of second housing 20 on the negative Z-axis direction side and extending in the negative Z-axis direction, is located at the terminal edge of first housing 10 on the positive Z-axis direction side and engaged with an engaged portion extending in the positive Z-axis direction. A mating structure is formed in which the engagement portion of second housing 20 is located outside the engaged portion of first housing 10. This makes it difficult for liquid to enter the interior of head-up display 1.

Image-generating device 50 generates an image and outputs image light indicating the generated image so that the image is projected onto windshield 3. More specifically, image-generating device 50 emits image light from a display component. The image light emitted from the display component of image-generating device 50 is reflected by first reflective mirror 31 and then also reflected by second reflective mirror 32, passes through first opening 11, and enters and transmits through cover 40. The image light then passes through second opening 22 and is emitted from head-up display 1 to be projected onto windshield 3. That is, image-generating device 50 can project a predetermined image onto windshield 3 by emitting image light. When the image light is reflected by windshield 3, the user can recognize a virtual image. Image-generating device 50 is, for example, a liquid crystal display device including a liquid crystal display and other components.

Image-generating device 50 includes a display component, a container, a light-emitting module, and a condenser lens.

The display component is a liquid crystal display element such as a liquid crystal display. In the display component, the light emitted from the light-emitting module is emitted from the back surface side of the display component so that the emitting surface emits light. In the display component, image light, indicating an image including numbers, characters, figures, and the like, is emitted from the emitting surface in response to a control instruction from an electronic control unit (ECU) installed in vehicle 2.

The display component is driven by AC power obtained from a power supply in vehicle 2.

The container is an enclosure that houses a display component, a light-emitting module, and a condenser lens. The container is disposed on the bottom plate of first housing 10.

The light-emitting module includes a light source and a substrate on which the light source is mounted. The light source is mounted on the substrate that is held to emit light toward the display component from the back side of the display component through the condenser lens. The light source is formed by, for example, light-emitting diodes. For example, the light source is driven by DC power obtained from the power supply in vehicle 2.

The condenser lens is disposed on the light emission direction side of the light source and disposed on an optical path between the light source and the display component. The condenser lens emits light emitted from the light source toward the display component.

First reflective mirror 31 reflects the image light emitted from image-generating device 50 toward second reflective mirror 32. Second reflective mirror 32 reflects the image light emitted from image-generating device 50 toward cover 40 through first opening 11.

Specifically, first reflective mirror 31 and second reflective mirror 32 are arranged in first housing 10 so as to face each other while being separated by a predetermined distance. More specifically, first reflective mirror 31 is disposed on the negative X-axis direction side of first housing 10 so as to face the emitting surface of image-generating device 50 and second reflective mirror 32, which are arranged on the positive X-axis direction side of first housing 10. First reflective mirror 31 and second reflective mirror 32 are arranged between image-generating device 50 and first opening 11. Second reflective mirror 32 faces first reflective mirror 31 and is disposed on the positive X-axis direction side of first reflective mirror 31. That is, second reflective mirror 32 is disposed to be aligned with first reflective mirror 31 in the X-axis direction.

First reflective mirror 31 and second reflective mirror 32 are concave mirrors, convex mirrors, or plane mirrors. In the present embodiment, each of first reflective mirror 31 and second reflective mirror 32 is a concave mirror with a free-form surface. In the present embodiment, each of first reflective mirror 31 and second reflective mirror 32 is a rectangular mirror that is long in the Y-axis direction. Note that the shapes of first reflective mirror 31 and second reflective mirror 32 are not particularly limited, and may be polygonal or circular.

Second reflective mirror 32 may be swingable about the Y-axis direction. In this case, the position of the image projected onto windshield 3 can be adjusted. Second reflective mirror 32 may be swingable by manual operation or electric operation using a drive mechanism.

Second housing 20 is disposed closer to windshield 3 than first housing 10 and coupled to first housing 10. Second housing 20 is made of resin material. A structure that includes first housing 10 and second housing 20 is an example of a housing.

As illustrated in FIG. 3, second housing 20 has a flat rectangular shape and is a frame-shaped body with rectangular second opening 22, formed in a center portion, for allowing image light to pass to the outside. Note that the shape of second housing 20 and the shape of second opening 22 are not limited to a rectangular shape. The shape of second housing 20 and the shape of second opening 22 may be set as appropriate according to the space for installing head-up display 1 in vehicle 2. Therefore, the shape of second housing 20 and the shape of second opening 22 may be a polygonal shape other than a rectangular shape, a circular shape, or any other known shape.

Second housing 20 supports plate-shaped cover 40 covering second opening 22. Placement surface 120 for placing cover 40 is formed on second housing 20. With cover 40 placed and supported on placement surface 120, cover 40 covers second opening 22. As illustrated in FIG. 4, second opening 22 faces first opening 11 of first housing 10, and second opening 22 and first opening 11 are arranged side by side in the Z-axis direction.

As illustrated in FIGS. 3 and 4, second housing 20 includes wall 21 disposed around second opening 22. Specifically, second opening 22 is surrounded by placement surface 120, and wall 21 is disposed around placement surface 120.

Placement surface 120 is curved so that the center portion in the X-axis direction is recessed. Specifically, placement surface 120 includes a pair of first placement surfaces 121 extending in the X-axis direction and a pair of second placement surfaces 122 extending in the Y-axis direction. The pair of first placement surfaces 121 are inclined upward in the negative X-axis direction and curved so that the inclination of tangent lines tangent to the pair of first placement surfaces 121 with respect to the X-axis direction gradually increases. The Y-axis direction of the pair of second placement surfaces 122 is substantially parallel to the Y-axis direction, but may be curved to be recessed in the negative Z-axis direction. In the present embodiment, the pair of first placement surfaces 121 and the pair of second placement surfaces 122 may be collectively referred to as placement surface 120.

Wall 21 rises from the surface of second housing 20 on the positive Z-axis direction side, that is, from the terminal edge of placement surface 120, and surrounds second opening 22 and placement surface 120. Surrounding second opening 22 and placement surface 120 may refer to completely surrounding second opening 22 and placement surface 120, or substantially surrounding these with one or more drainage structures 26 formed and cut into wall 21.

The outer peripheral shape of wall 21 surrounding second opening 22 is asymmetric in the first direction and the second direction (X-axis direction and Y-axis direction) and is similar to the shape of second opening 22. Although wall 21 of the present embodiment does not completely surround second opening 22 with drainage structure 26 or the like, the outer peripheral shape of wall 21 is a shape regarded as completely surrounding second opening 22. The X-axis direction is an example of the first direction. The Y-axis direction is an example of the second direction.

Wall 21 includes a pair of first extensions 21a facing each other across second opening 22 and extending in the X-axis direction, a pair of second extensions 21b extending in the Y-axis direction in a direction different from the X-axis direction, and a plurality of claw parts 24 arranged along wall 21.

The pair of first extensions 21a extend in the X-axis direction. One first extension 21a of the pair of first extensions 21a is disposed on the positive Y-axis direction side of second opening 22. The other first extension 21a of the pair of first extensions 21a is disposed on the negative Y-axis direction side of second opening 22.

As described above, first placement surface 121 is curved, so that the pair of first extensions 21a is curved toward image-generating device 50, as illustrated in FIG. 4.

As illustrated in FIG. 3, the pair of second extensions 21b extend in the Y-axis direction. One second extension 21b1 of the pair of second extensions 21b is disposed on the front side (positive X-axis direction side) of vehicle 2. Other second extension 21b2 of the pair of second extensions 21b is disposed on the rear side (negative X-axis direction side) of vehicle 2.

As illustrated in FIG. 5, one second extension 21b1 is longer than other second extension 21b2. Note that one second extension 21b1 and other second extension 21b2 may have the same length. Other second extension 21b2 may be longer than one second extension 21b1.

In the present embodiment, the interval between two adjacent claw parts 24 provided on one second extension 21b1 is smaller than the interval between two adjacent claw parts 24 provided on other second extension 21b2, and one second extension 21b1 is longer than other second extension 21b2. Therefore, the number of claw parts 24 provided on one second extension 21b1 is smaller than the number of claw parts 24 provided on other second extension 21b2.

Each of the plurality of claw parts 24 includes a presser protruding from wall 21 toward second opening 22. The plurality of claw parts 24 include first claw parts 24a arranged along the pair of first extensions 21a and second claw parts 24b arranged along the pair of second extensions 21b.

Specifically, first claw parts 24a are arranged along the pair of first extensions 21a. In the present embodiment, two or more first claw parts 24a are arranged side by side along the pair of first extensions 21a. Two or more first claw parts 24a are provided on the pair of first placement surfaces 121 formed along the pair of first extensions 21a. In the present embodiment, three first claw parts 24a are provided on each of the pair of first placement surfaces 121. Note that the number of first claw parts 24a provided on each of the pair of first placement surfaces 121 may be two or less, or four or more. The number of first claw parts 24a provided on one first placement surface 121 of the pair of first placement surfaces 121 and the number of first claw parts 24a provided on the other first placement surface 121 of the pair of first placement surfaces 121 may be the same or different.

As illustrated in FIGS. 6 and 7, first claw part 24a includes base 225 protruding in the positive Z-axis direction and first presser 224a protruding in the negative X-axis direction from the leading end of base 225. First presser 224a also extends in the Y-axis direction toward second opening 22. That is, first presser 224a extends from base 225 in the Y-axis direction and in the negative X-axis direction. First presser 224a is an example of a presser.

Since first presser 224a faces first placement surface 121 with cover 40 therebetween, the movement of cover 40 in the Z-axis direction can be inhibited.

First presser 224a is a protruding plate extending from each of the pair of first extensions 21a toward second opening 22. Inclined portion 224b inclined upward away from first placement surface 121 is coupled to first presser 224a. Inclined portion 224b is also coupled to base 225.

Inclined portion 224b is a plate portion inclined upward in the negative Y-axis direction. Inclined portion 224b extends from base 225 in the negative X-axis direction and extends from first presser 224a in the negative Y-axis direction. Inclined portion 224b can guide cover 40 to first presser 224a when cover 40 is attached to second housing 20.

As illustrated in FIG. 8, drainage structure 26 is formed in second housing 20. Drainage structure 26 is a drainage hole penetrating in a direction orthogonal to the longitudinal direction of the pair of first extensions 21a or a recess in the direction orthogonal to the longitudinal direction of the pair of first extensions 21a. Drainage structure 26 extends vertically downward (in the negative Z-axis direction) from the surface of cover 40. Thus, even if water drops fall on the surface of cover 40, the water drops are drained from the drainage structure 26.

Drainage structures 26 are formed at positions corresponding to the plurality of first claw parts 24a arranged along each of the pair of first extensions 21a. That is, drainage structures 26 are formed in the negative Z-axis direction of the plurality of first claw parts 24a.

As illustrated in FIG. 5 and (a) of FIG. 9, second claw part 24b protrudes in the X-axis direction from each of the pair of second extensions 21b toward second opening 22. The second claw part 24b includes second presser 224c extending from each of the pair of second extensions 21b toward second opening 22, and inclined portion 224d coupled to second presser 224c and each of the pair of second extensions 21b and inclined upward away from second placement surface 122 with respect to second presser 224c. Second presser 224c is an example of a presser. In the present embodiment, first presser 224a and second presser 224c may be collectively referred to as a presser.

Second presser 224c disposed on one second extension 21b1 extends in the negative X-axis direction from the surface of one second extension 21b1 on the side of second opening 22. Second presser 224c disposed on other second extension 21b2 extends in the positive X-axis direction from the surface of other second extension 21b2 on the side of second opening 22. Since second presser 224c faces second placement surface 122 with cover 40 therebetween, the movement of cover 40 in the Z-axis direction can be inhibited.

Second presser 224c is a protruding plate extending from each of the pair of second extensions 21b toward second opening 22. Inclined portion 224d inclined upward away from second placement surface 122 is coupled to second presser 224c.

Inclined portion 224d of second extension 21b is a plate portion inclined upward in the negative Y-axis direction. Inclined portion 224d can guide cover 40 when cover 40 is attached to second housing 20.

Second placement surface 122 includes protrusions 25 disposed along the pair of second extensions 21b. Protrusions 25 engage with cover 40 to inhibit the movement of cover 40 in the X-axis direction and the Y-axis direction.

Protrusions 25 are located on both end sides and the center side of one second extension 21b1 and at least on the center side of other second extension 21b2. Protrusions 25 may further be located on both end sides of other second extension 21b2. Protrusion 25 located on the center side of one second extension 21b1 and protrusion 25 located on the center side of other second extension 21b2 do not overlap in the X-axis direction. That is, protrusion 25 located on the center side of one second extension 21b1 and protrusion 25 located on the center side of other second extension 21b2 are displaced in the Y-axis direction so as not to overlap in the X-axis direction.

Drainage structure 26 is formed in one second extension 21b1. Drainage structure 26 is a drainage hole penetrating in a direction orthogonal to the longitudinal direction of one second extension 21b1, or a notched recess cut in a direction orthogonal to the longitudinal direction of other second extension 21b1. Drainage structure 26 extends vertically downward (in the negative Z-axis direction) from the surface of cover 40. Thus, even if water drops fall on the surface of cover 40, the water drops are drained from the drainage structure 26. Note that drainage structure 26 may also be formed in other second extension 21b2.

Drainage structures 26 are formed at positions corresponding to the plurality of second claw parts 24b arranged along each of the pair of second extensions 21b. That is, drainage structures 26 are formed in the negative Z-axis direction of the plurality of second claw parts 24b.

Cover 40 is made of a translucent resin material such as polycarbonate (PC) or acrylic, or a polarizing plate. Since the image light transmitted through first opening 11 passes through second opening 22, the image light transmitted through cover 40 is projected onto windshield 3.

Cover 40 also serves as an antifouling cover for inhibiting dust from entering first housing 10. For example, the surface of cover 40 on the side of windshield 3 may be subjected to hard coating treatment. In this case, even if dust adheres to the surface, dirt can be easily wiped off. The surface of cover 40 on the side of windshield 3 is the surface of cover 40 on the positive X-axis direction side, and is an emitting surface from which image light is emitted. The surface of cover 40 may have an antireflection coating.

Cover 40 is supported by placement surface 120 of second housing 20, wall 21 of second housing 20, the plurality of claw parts 24, and the plurality of protrusions 25.

Specifically, cover 40 includes a plurality of first engagement portions 41 formed corresponding to the plurality of claw parts 24, and a plurality of second engagement portions 42 formed corresponding to the plurality of protrusions 25. In the present embodiment, the plurality of first engagement portions 41 are at least either a plurality of through holes or a plurality of notches.

The plurality of first engagement portions 41 are formed at positions corresponding to the plurality of claw parts 24 when cover 40 is placed on placement surface 120 of second housing 20, and the plurality of second engagement portions 42 are formed at positions corresponding to the plurality of protrusions 25 when cover 40 is placed on placement surface 120 of the housing. Second engagement portion 42 of cover 40 is a long hole in the Y-axis direction that allows cover 40 to slide.

As illustrated in FIG. 6, first engagement portion 41 disposed on the negative Y-axis direction side includes the following: first engagement hole 41a, through which claw part 24 provided on first placement surface 121 is inserted when cover 40 is assembled to second housing 20; and second engagement hole 41b, through which base 225 is inserted when cover 40 is slid in the positive Y-axis direction. First engagement portion 41 disposed on the negative Y-axis direction side has an L-shape formed by first engagement hole 41a and second engagement hole 41b. As illustrated in FIG. 7, when base 225 is inserted in second engagement hole 41b, cover 40 is placed to be sandwiched between first presser 224a and first placement surface 121.

Cover 40 has a shape corresponding to the outer peripheral shape of wall 21. Therefore, the shape of cover 40 is asymmetric in the X-axis direction and the Y-axis direction and is similar to the shape of second opening 22.

In second housing 20, cover 40 is surrounded by the pair of first extensions 21a and the pair of second extensions 21b by wall 21 and second engagement portions 42 of cover 40. Cover 40 can be sandwiched between the pressers of the plurality of claw parts 24 inserted into first engagement portions 41 and placement surface 120 of second housing 20, using the plurality of claw parts 24 and the plurality of first engagement portions 41. The plurality of protrusions 25 engage with second engagement portions 42 in a state where cover 40 is held by the pressers, the pair of first extensions 21a, and the pair of second extensions 21b. That is, second housing 20 can be engaged with cover 40 using the plurality of protrusions 25 and the plurality of second engagement portions 42 of cover 40. As a result, second housing 20 can hold cover 40 in a curved state. That is, second housing 20 can hold cover 40 in a curved state along placement surface 120, which is curved so that the center portion in the X-axis direction is recessed.

Therefore, even if cover 40 is pressed when, for example, dust adhering to the surface of cover 40 is wiped off, cover 40 can be inhibited from lifting because cover 40 is supported by wall 21, the plurality of claw parts 24, and the plurality of protrusions 25.

In head-up display 1, image light emitted from image-generating device 50 enters first reflective mirror 31 and is reflected by first reflective mirror 31. The image light then enters second reflective mirror 32, is reflected by second reflective mirror 32, passes through first opening 11, and enters cover 40 supported by second opening 22 of second housing 20. The image light entering cover 40 transmits cover 40, and the image light is projected onto windshield 3.

A procedure for attaching cover 40 to second housing 20 in head-up display 1 will be described with reference to (a) to (f) of FIG. 9.

(a) to (f) of FIG. 9 are schematic explanatory views illustrating how cover 40 is attached to second housing 20.

As illustrated in (a) to (c) of FIG. 9, cover 40 is moved in the negative Z-axis direction to cover second opening 22 of second housing 20.

Specifically, cover 40 is placed on placement surface 120 to cover second opening 22 of second housing 20 so that the plurality of claw parts 24 of second housing 20 and the plurality of first engagement portions 41 of cover 40 correspond one-to-one, and the plurality of protrusions 25 of second housing 20 and the plurality of second engagement portions 42 of cover 40 correspond one-to-one.

Cover 40 is engaged with second housing 20 while being lowered in the negative Z-axis direction so that the plurality of claw parts 24 of second housing 20 and the plurality of first engagement portions 41 of cover 40 correspond one-to-one, and the plurality of protrusions 25 of second housing 20 and the plurality of second engagement portions 42 of cover 40 correspond one-to-one. Thus, the plurality of claw parts 24 of second housing 20 and the plurality of first engagement portions 41 of cover 40 are engaged one-to-one, and the plurality of protrusions 25 of second housing 20 and the plurality of second engagement portions 42 of cover 40 are engaged one-to-one. As a result, cover 40 is placed on placement surface 120 of second housing 20.

Next, cover 40 is slid in the positive Y-axis direction. As illustrated in (d) to (f) of FIG. 9, the sliding of cover 40 moves the plurality of first engagement portions 41, and cover 40 is placed between placement surface 120 and the pressers of the plurality of claw parts 24. In the present embodiment, the sliding cover 40 in the positive Y-axis direction enables cover 40 to be sandwiched between placement surface 120 and the pressers of the plurality of claw parts 24 inserted into the plurality of first engagement portions 41.

Thus, cover 40 is inhibited from moving in the Z-axis direction by the pressers of the plurality of claw parts 24 and inhibited from moving in the X-axis direction and the positive Y-axis direction by the plurality of claw parts 24 and the plurality of protrusions 25. Therefore, second housing 20 can be inhibited from lifting against placement surface 120.

### Operations and Effects

Next, the operations and effects of head-up display 1 according to the present embodiment will be described.

For example, in a head-up display, when a cover is attached to a housing, the cover may be attached to the housing using a separate member such as double-sided tape or pins. In this case, the installation cost and the assembling man-hour increase due to the necessity for jigs and pressurizing equipment, and the material cost of the separate member is required. This results in higher cost, as well as a larger outside shape of the wall of the head-up display with an opening, which may affect the ease of in-vehicle mounting and the appearance design of a dashboard (also referred to as an instrument panel).

In contrast, the projection device of PTL 1 discloses the configuration in which the housing holds the cover in a state where the cover is sandwiched between the edge and the pressers inserted into the through holes. However, when the cover is pressed from the outside or continuously exposed to a high-temperature environment, the cover may deform and lift from the edge. In this case, there is a problem that the quality of the cover deteriorates, and a gap is formed between the cover and the edge, allowing dust to enter through the gap.

Therefore, as described above, head-up display 1 according to technique 1 of the present embodiment is head-up display 1 provided in vehicle 2 to project image light onto an object capable of transmitting and reflecting light, and form a virtual image on the side opposite to an observer relative to the object. Head-up display 1 includes: image-generating device 50 configured to project the image light onto the object; a housing (second housing 20) that houses image-generating device 50 and includes an opening (second opening 22) for allowing the image light to pass to the outside, and wall 21 disposed around the opening (second opening 22); and plate-shaped cover 40 supported by placement surface 120 of the housing (second housing 20), and covering the opening (second opening 22). Wall 21 includes: a pair of first extensions 21a facing each other across the opening (second opening 22) and extending in a first direction (X-axis direction); a pair of second extensions 21b extending in a second direction (Y-axis direction) that is a direction different from the first direction (X-axis direction); and a plurality of claw parts 24 arranged along wall 21. The pair of first extensions 21a are curved toward image-generating device 50. Cover 40 includes a plurality of first engagement portions 41 that are formed corresponding to the plurality of claw parts 24. Each of the plurality of claw parts 24 includes a presser that protrudes from wall 21 toward the opening (second opening 22). The housing (second housing 20) holds cover 40 in a curved state by surrounding cover 40 with the pair of first extensions 21a and the pair of second extensions 21b and sandwiching cover 40 between placement surface 120 and the pressers engaged with the plurality of first engagement portions 41.

With this configuration, cover 40 can be sandwiched between the plurality of claw parts 24 and placement surface 120, and thus, even if cover 40 supported by placement surface 120 is pressed, wall 21 and the plurality of claw parts 24 can support cover 40. Therefore, the plurality of claw parts 24 can inhibit cover 40 from lifting.

In addition, since cover 40 is sandwiched between the plurality of claw parts 24 and placement surface 120, it is not necessary to separately couple cover 40 to second housing 20 using a double-sided tape or the like.

Therefore, according to the present disclosure, it is possible to inhibit cover 40 from lifting while inhibiting an increase in size. According to the present disclosure, since cover 40 can be held by second housing 20 without using double-sided tape or the like, substantial increases in the material cost and manufacturing cost of head-up display 1 can be inhibited.

Further, head-up display 1 according to technique 2 of the present embodiment is head-up display 1 according to technique 1, wherein the plurality of claw parts 24 are provided on the pair of second extensions 21b, and the presser protrudes in the first direction (X-axis direction) toward the opening (second opening 22).

With this configuration, the lifting of cover 40 placed along the pair of second extensions 21b can be inhibited. In particular, the lifting of cover 40 in the front-rear direction of vehicle 2 can be inhibited.

Further, head-up display 1 according to technique 3 of the present embodiment is head-up display 1 according to technique 2, wherein the plurality of claw parts 24 are arranged along the pair of first extensions 21a, and the presser extends in the second direction (Y-axis direction) toward the opening (second opening 22).

With this configuration, the lifting of cover 40 placed along the pair of first extensions 21a can be inhibited. In particular, the lifting of cover 40 in the left-right direction of vehicle 2 can be inhibited.

Further, head-up display 1 according to technique 4 of the present embodiment is head-up display 1 according to technique 3, wherein one second extension 21b1 of the pair of second extensions 21b is disposed on the front side of vehicle 2, other second extension 21b2 of the pair of second extensions 21b is disposed on the rear side of vehicle 2, and the number of claw parts 24 provided on one second extension 21b1 is smaller than the number of claw parts 24 provided on other second extension 21b2.

With this configuration, the lifting from one second extension 21b1 can be further inhibited. For example, when one second extension 21b1 is longer than other second extension 21b2, the number of claw parts 24 provided on one second extension 21b1 can be increased, so that the lifting from one second extension 21b1 can be inhibited.

It is considered that in particular, when the surface of cover 40 in head-up display 1 is pressed from the seat side, cover 40 is often pressed from the rear of vehicle 2 toward the front of vehicle 2. In this case, pressing from the rear to the front of vehicle 2 may cause the front side of cover 40 to lift off first placement surface 121. However, according to the present embodiment, the lifting from one second extension 21b1 can be further inhibited, thus inhibiting dust from entering through the gap between second housing 20 and cover 40.

Further, head-up display 1 according to technique 5 of the present embodiment is head-up display 1 according to any one of techniques 1 to 4, wherein cover 40 includes second engagement portion 42, placement surface 120 (second placement surface 122) includes protrusion 25 disposed along each of the pair of second extensions 21b, and protrusion 25 is engaged with second engagement portion 42 in a state where cover 40 is held by the presser, the pair of first extensions 21a, and the pair of second extensions 21b.

With this configuration, when cover 40 is attached to second housing 20, claw part 24 and first engagement portion 41 of cover 40 correspond to each other, and protrusion 25 of second housing 20 and second engagement portion 42 of cover 40 correspond to each other, so that cover 40 can be slid in a predetermined direction without rattling. That is, the engagement of claw part 24 with first engagement portion 41 and the engagement of protrusion 25 with second engagement portion 42 make it possible to position cover 40 and inhibit the movement of cover 40 in the X-axis direction. As a result, cover 40 can be easily attached to second housing 20.

Further, head-up display 1 according to technique 6 of the present embodiment is head-up display 1 according to technique 5, wherein one second extension 21b1 of the pair of second extensions 21b is disposed on the front side of vehicle 2, other second extension 21b2 of the pair of second extensions 21b is disposed on the rear side of vehicle 2, and protrusions 25 are located on both end sides and the center side of one second extension 21b1, and located at least on the center side of other second extension 21b2.

With this configuration, the lifting from one second extension 21b1 can be further inhibited. For example, when one second extension 21b1 is longer than other second extension 21b2, the number of claw parts 24 provided on one second extension 21b1 can be increased, so that the lifting from one second extension 21b1 can be inhibited.

Further, head-up display 1 according to technique 7 of the present embodiment is head-up display 1 according to technique 6, wherein protrusions 25 are further located on both end sides of other second extension 21b2.

With this configuration, the lifting from one second extension 21b1 can be further inhibited.

Further, head-up display 1 according to technique 8 of the present embodiment is head-up display 1 according to technique 6 or 7, wherein the outer peripheral shape of wall 21 surrounding the opening (second opening 22) is asymmetric in the X-axis direction and the Y-axis direction and is similar to the shape of the opening (second opening 22), and protrusion 25 located on the center side of one second extension 21b1 and protrusion 25 located on the center side of other second extension 21b2 do not overlap in the X-axis direction.

With this configuration, since protrusions 25 can be disposed on the center side of one second extension 21b1 and the center side of other second extension 21b2 according to the outer peripheral shape of the asymmetric wall 21, even if these protrusions 25 do not overlap in the X-axis direction, wall 21, the plurality of claw parts 24, and the plurality of protrusions 25 can support cover 40. Therefore, the lifting of cover 40 can be inhibited.

Further, head-up display 1 according to technique 9 of the present embodiment is head-up display 1 according to any one of techniques 1 to 8, wherein one second extension 21b1 of the pair of second extensions 21b is disposed on the front side of vehicle 2, other second extension 21b2 of the pair of second extensions 21b is disposed on the rear side of vehicle 2, and one second extension 21b1 is longer than other second extension 21b2.

With this configuration, the shape of head-up display 1 can be set in accordance with the size and shape of the space of vehicle 2 in which head-up display 1 is disposed.

Further, head-up display 1 according to technique 10 of the present embodiment is head-up display 1 according to any one of techniques 1 to 9, wherein drainage structure 26 is formed in each of the pair of first extensions 21a, and drainage structure 26 extends vertically downward from the surface of cover 40.

With this configuration, even if the liquid adheres to the surface of cover 40, the liquid on the surface of cover 40 can be drained out of drainage structure 26. Therefore, the image light entering cover 40 can be properly projected onto windshield 3 without the liquid entering the interior of head-up display 1.

Drainage structure 26 formed in each of the pair of first extensions 21a is larger than drainage structure 26 formed in each of the pair of second extensions 21b. This not only drains the liquid adhering to the surface of cover 40, but also makes it easier for the operator's fingers to enter and perform assembly, positioning, and sliding operations. Of three drainage structures 26 formed in each of the pair of first extensions 21a, all three drainage structures 26 may be larger than drainage structure 26 formed in the pair of second extensions 21b, or one or two drainage structures 26 of three drainage structures 26 may be larger than drainage structure 26 formed in the pair of second extensions 21b.

Further, head-up display 1 according to technique 11 of the present embodiment is head-up display 1 according to any one of techniques 1 to 10, wherein one second extension 21b1 of the pair of second extensions 21b is disposed on the front side of vehicle 2, drainage structure 26 is formed in one second extension 21b1, and drainage structure 26 extends vertically downward from the surface of cover 40.

With this configuration, even if liquid adheres to the surface of cover 40, the liquid flows to one second extension 21b1 in the vertical downward direction, allowing the liquid on the surface of cover 40 to drain out of drainage structure 26 of one second extension 21b1. Therefore, the image light entering cover 40 can be properly projected onto windshield 3 without the liquid entering the interior of head-up display 1.

Further, head-up display 1 according to technique 12 of the present embodiment is head-up display 1 according to any one of techniques 1 to 11, wherein the presser (first presser 224a) extends from each of the pair of first extensions 21a toward the opening (second opening 22), and inclined portion 224b inclined upward away from placement surface 120 is coupled to the presser (first presser 224a).

With this configuration, during the attachment of cover 40 to second housing 20, inclined portion 224b can guide cover 40 as cover 40 is placed on placement surface 120 and slid in the Y-axis direction. Therefore, cover 40 can be sandwiched between the plurality of claw parts 24 and placement surface 120.

Further, head-up display 1 according to technique 13 of the present embodiment is head-up display 1 according to any one of techniques 1 to 12, wherein the presser (second presser 224c) extends from each of the pair of second extensions 21b toward the opening (second opening 22), and inclined portion 224d inclined upward away from placement surface 120 is coupled to the presser (second presser 224c).

With this configuration, during the attachment of cover 40 to second housing 20, inclined portion 224d can guide cover 40 as cover 40 is placed on placement surface 120 and slid in the Y-axis direction. Therefore, cover 40 can be sandwiched between the plurality of claw parts 24 and placement surface 120.

### Other Variations, Etc.

Although the head-up display according to the present disclosure has been described based on the embodiment described above, the present disclosure is not limited to the embodiment. Ones obtained by applying various modifications conceivable by those skilled in the art to the embodiment may also be included within the scope of the present disclosure, as long as they do not depart from the gist of the present disclosure.

Note that the present disclosure also includes forms obtained by applying various modifications conceivable by those skilled in the art to the above embodiment, and forms realized by arbitrarily combining components and functions in the embodiment without departing from the gist of the present disclosure.

### Further Information about Technical Background to this Application

The disclosure of the following patent application including specification, drawings, and claims is incorporated herein by reference in their entirety: Japanese Patent Application No. 2024-028278 filed on Feb. 28, 2024.

### INDUSTRIAL APPLICABILITY

The present disclosure is applicable to mobile objects such as vehicles, for example.

1. A head-up display provided in a vehicle to project image light onto an object capable of transmitting and reflecting light, and form a virtual image on a side opposite to an observer relative to the object, the head-up display comprising:
an image-generating device configured to project the image light onto the object;
a housing that houses the image-generating device, and includes an opening and a wall disposed around the opening, the opening allowing the image light to pass to outside; and
a cover that is plate-shaped, is supported by a placement surface of the housing, and covers the opening,
wherein the wall includes:
a pair of first extensions facing each other across the opening and extending in a first direction;
a pair of second extensions extending in a second direction different from the first direction; and
a plurality of claw parts arranged along the wall,
the pair of first extensions are curved toward the image-generating device,
the cover includes a plurality of first engagement portions that are provided corresponding to the plurality of claw parts,
each of the plurality of claw parts includes a presser that protrudes from the wall toward the opening, and
the housing holds the cover in a curved state by surrounding the cover with the pair of first extensions and the pair of second extensions and sandwiching the cover between the placement surface and the presser engaged with each of the plurality of first engagement portions.

2. The head-up display according to claim 1,
wherein the plurality of claw parts are provided on the pair of second extensions, and
the presser protrudes in the first direction toward the opening.

3. The head-up display according to claim 2,
wherein the plurality of claw parts are arranged along the pair of first extensions, and
the presser extends in the second direction toward the opening.

4. The head-up display according to claim 3,
wherein one second extension of the pair of second extensions is disposed on a front side of the vehicle,
an other second extension of the pair of second extensions is disposed on a rear side of the vehicle, and
a total number of claw parts provided on the one second extension is smaller than a total number of claw parts provided on the other second extension.

5. The head-up display according to claim 1,
wherein the cover includes a second engagement portion,
the placement surface includes a protrusion disposed along each of the pair of second extensions, and
the protrusion is engaged with the second engagement portion in a state where the cover is held by the presser, the pair of first extensions, and the pair of second extensions.

6. The head-up display according to claim 5,
wherein one second extension of the pair of second extensions is disposed on the front side of the vehicle,
an other second extension of the pair of second extensions is disposed on the rear side of the vehicle, and
the protrusion is located on each of a center side and both end sides of the one second extension, and is located at least on a center side of the other second extension.

7. The head-up display according to claim 6,
wherein the protrusion is further located on each of both end sides of the other second extension.

8. The head-up display according to claim 6,
wherein an outer peripheral shape of the wall surrounding the opening is asymmetric in the first direction and the second direction and is similar to a shape of the opening, and
the protrusion located on the center side of the one second extension and the protrusion located on the center side of the other second extension do not overlap in the first direction.

9. The head-up display according to claim 1,
wherein one second extension of the pair of second extensions is disposed on the front side of the vehicle,
an other second extension of the pair of second extensions is disposed on the rear side of the vehicle, and
the one second extension is longer than the other second extension.

10. The head-up display according to claim 1,
wherein a drainage structure is provided on each of the pair of first extensions, and
the drainage structure extends vertically downward from a surface of the cover.

11. The head-up display according to claim 1,
wherein one second extension of the pair of second extensions is disposed on the front side of the vehicle,
a drainage structure is provided on the one second extension, and
the drainage structure extends vertically downward from a surface of the cover.

12. The head-up display according to claim 1,
wherein the presser extends from each of the pair of first extensions toward the openings, and
an inclined portion inclined upward away from the placement surface is coupled to the presser.

13. The head-up display according to claim 1,
wherein the pressers extend from each of the pair of second extensions toward the openings, and
an inclined portion inclined upward away from the placement surface is coupled to the presser.
